(19) United States
(12) Patent Application Publication
(10) Pub. No.: US 2019/0003558 A1
(43) Pub. Date: Jan. 3, 2019

(54) CHAIN GUIDE ASSEMBLY FOR AN INTERNAL COMBUSTION ENGINE

(71) Applicant: GM Global Technology Operations LLC, Detroit, MI (US)

(72) Inventors: Vinit KUMAR, Karnataka (IN); Eric D. STALEY, Flushing, MI (US)

(21) Appl. No.: 15/638,321

(22) Filed: Jun. 29, 2017

(51) Int. Cl. F16H 7/08; F16H 7/18; F16H 7/06

(52) U.S. Cl. CPC F16H 7/0829; F16H 7/18; F16H 7/24; F16H 2007/185; F16H 7/06

(57) ABSTRACT

A chain drive system for an engine includes a plurality of sprockets. A chain is drivingly engaged with the plurality of sprockets. A guide assembly engages the chain and includes a metal support plate adapted to be secured to the engine and a plastic plate is supported by the metal plate and includes a chain guide surface in direct contact with the chain. An elastomeric insert is disposed between the metal plate and the plastic plate for reducing the transmission of noise and vibration between the plastic plate and the metal plate.

### FIELD

The present disclosure relates to a chain guide assembly for an internal combustion engine for reduced noise and vibration.

### BACKGROUND

This section provides background information related to the present disclosure which is not necessarily prior art.

Chain guides and tensioners are used for guiding and applying tension against a chain for preventing chain rattle in an auxiliary drive system of an engine or in other industrial machines. In conventional chain guides, a metal plate is used to support a plastic plate direct engagement with the chain. Vibrations imparted to the plastic plate are then transmitted to the metal plate which can produce a rattle noise in the timing drive system. Accordingly, it is desirable to provide a chain guide system that has reduced noise and vibration.

### SUMMARY

This section provides a general summary of the disclosure, and is not a comprehensive disclosure of its full scope or all of its features.

A chain drive system for an engine includes a plurality of sprockets. A chain is drivingly engaged with the plurality of sprockets. A guide assembly engages the chain and includes a metal support plate adapted to be secured to the engine and a plastic plate is supported by the metal plate and includes a chain guide surface in direct contact with the chain. An elastomeric insert is disposed between the metal plate and the plastic plate for reducing the transmission of noise and vibration between the plastic plate and the metal plate.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of a chain drive system employing a chain guide according to the principles of the present disclosure;

FIG. 2 is a plan view of a chain guide according to the principles of the present disclosure; and

FIG. 3 is an exploded perspective view of the chain guide assembly of FIG. 2.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

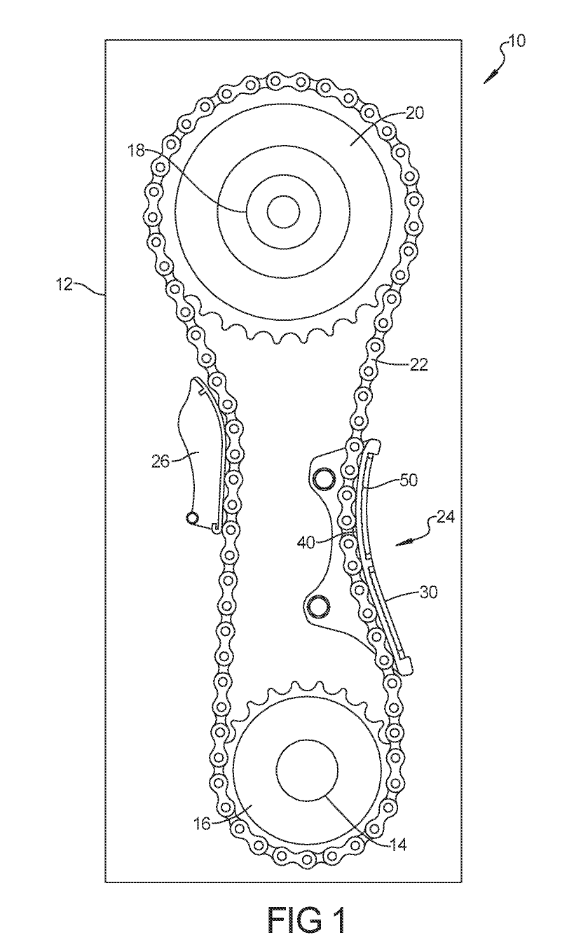

With reference to FIG. 1, an internal combustion engine 10 is shown including an engine structure 12 that defines a plurality of cylinders. As is known in the art, a plurality of pistons is disposed within the cylinders of the internal combustion engine 10. A crankshaft 14 is in driving connection with each of the pistons. A drive sprocket 16 is connected to the crankshaft 14. A camshaft 18 is provided in connection with a plurality of valve members associated with each of the cylinders. A driven sprocket 20 is connected to the camshaft 18 and a chain is drivingly engaged between the drive sprocket 16 and driven sprocket 20. A chain guide assembly 24 is provided for guiding the chain between the drive and driven sprocket's 16, 20. A chain tensioner 26 can be provided for applying a tension force against the chain 22. The chain tensioner 26 can be of any known design.

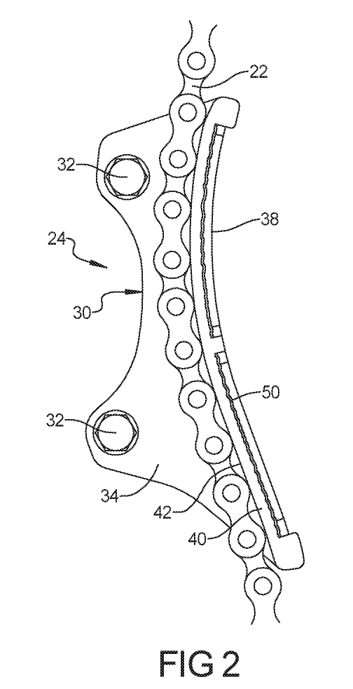

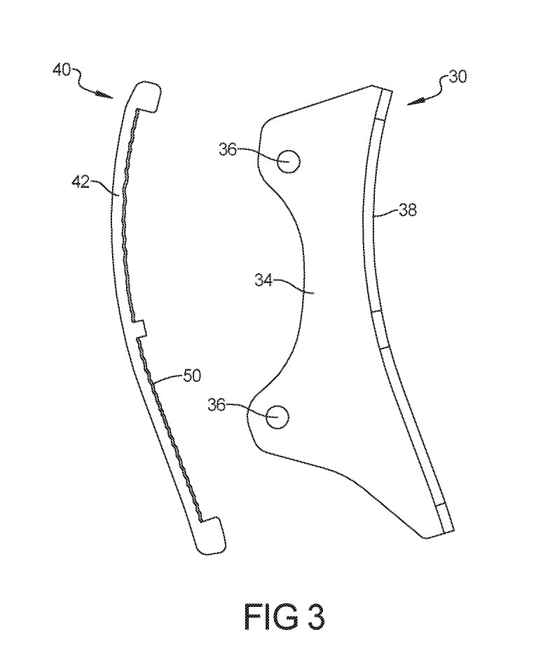

With reference to FIGS. 2 and 3, the chain guide assembly 24 will now be described. The chain guide assembly includes a metal plate 30 that can be mounted to the engine structure 12 by one or more fasteners 32 the metal plate 30 can be made from steel or other material and includes a mounting flange portion 34 that includes apertures 36 for receiving the fasteners 32 and a curved support surface 38 extending from the mounting flange portion 34. A plastic plate 40 is supported by the metal plate 30 and includes a chain guide surface 42 that is in direct contact with the chain 22. An elastomeric insert 50 is disposed between the curved support surface 38 of the metal plate 30 and the plastic plate 40. The elastomeric insert 50 can reduce rattle noise in timing drive systems which generally occurs due to impact between the chain 22 and the fixed guide assembly 24. The elastomeric insert 50 can be made from a rubber (such as NHBR), silicone or other elastomeric material. The elastomeric insert 50 can also be provided with non-uniform thickness or coverage between the metal plate 30 and plastic plate 40 depending upon the specific application and its noise and vibration characteristics. In addition, it should also be understood that principles of the present disclosure can also be applied to the chain tensioner 26 by providing an elastomeric insert between a plastic plate and metal plate of the chain tensioner 26.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A chain drive system for an engine, comprising:
a plurality of sprockets;
a chain drivingly engaged with the plurality of sprockets;
a guide assembly engaging the chain and including a metal support plate adapted to be secured to the engine and a plastic plate supported by the metal plate and including a chain guide surface in direct contact with the chain, and an elastomeric insert disposed between the metal plate and the plastic plate.

2. The chain drive system according to claim 1, the metal plate is made from steel.

3. The chain drive system according to claim 1, wherein the elastomeric insert is made from rubber.

4. An internal combustion engine, comprising:
an engine structure including a plurality of cylinders;
a plurality of pistons disposed in the plurality of cylinders;
a crankshaft connected to the plurality of cylinders;
a drive sprocket attached to the crankshaft;
a camshaft drivingly engaged with a plurality of valves associated with the plurality of cylinders;
a driven sprocket attached to the camshaft;
a chain drivingly engaged with the drive and driven sprockets; and
a guide assembly engaging the chain and including a metal support plate adapted to be secured to the engine and a plastic plate supported by the metal plate and including a chain guide surface in direct contact with the chain, and an elastomeric insert disposed between the metal plate and the plastic plate.

5. The chain drive system according to claim 4, the metal plate is made from steel.

6. The chain drive system according to claim 4, wherein the elastomeric insert is made from rubber.
